(19) United States
(12) Patent Application Publication
(10) Pub. No.: US 2013/0290514 A1
(43) Pub. Date: Oct. 31, 2013

(54) DYNAMIC INTERSTITIAL TRANSITIONS

(71) Applicants: James W. McGowan, Whitehouse Station, NJ (US); Tom Janiszewski, Andover, NJ (US)

(72) Inventors: James W. McGowan, Whitehouse Station, NJ (US); Tom Janiszewski, Andover, NJ (US)

(73) Assignee: Alcatel-Lucent USA Inc., Murray Hill, NJ (US)

(21) Appl. No.: 13/458,523

(22) Filed: Apr. 27, 2012

(51) Int. Cl. H04L 29/06

(52) U.S. Cl. CPC H04L 65/60
USPC 709/224

(57) ABSTRACT

Techniques are disclosed for managing streaming content. For example, one method comprises monitoring one or more operating conditions of a communications network configured to provide at least one content stream to one or more communications devices. The method further comprises selecting an interstitial transition for insertion into the content stream based on a length of the interstitial transition, in response to the one or more monitored operating conditions of the communications network, wherein the interstitial transition is selected from a plurality of varied-length interstitial transitions.

### FIELD

The field relates generally to media signal processing and, more particularly, to techniques for managing jitter and bandwidth for streaming content.

### BACKGROUND

This section introduces aspects that may help facilitate a better understanding of the inventions. Accordingly, the statements of this section are to be read in this light and are not to be understood as admissions about what is prior art or what is not prior art.

Streaming content typically refers to a data stream that can be concurrently received by an end-user device and presented to an end-user. That is, the end-user device can start displaying data from a streaming data file before the entire file has been received by the end-user device. For example, streaming content is typically distributed over telecommunications networks, i.e., to mobile end-user devices (e.g., mobile telephones, tablets, laptops, etc.) from a streaming content provider (e.g., a content server).

Streaming content is known to have bandwidth and jitter issues. Bandwidth typically refers to a bit (and/or frame) rate or throughput associated with a content stream. Jitter typically refers to the variation in the time between data (e.g., packets) arriving at a destination, which may be caused by, for example, network congestion, timing drift and/or route changes. Thus, at any given time, the end-user device and/or the transmission network may suffer from bandwidth limitations and jitter problems.

There are existing techniques that attempt to manage bandwidth and jitter issues associated with streaming content. Some solutions insert a long playback delay into the content stream. However, these solutions are unsuitable for content involving conversations, prolonged live video, switching streams (channel change), or other situations in which low initial playback, typically below about 500 milliseconds, is desirable. When these solutions fail, they stall playback entirely, which end-users find particularly annoying. Other solutions involve adapting the bit rate and frame rate of the content streams. However, these solutions can compromise playback quality.

### SUMMARY

Embodiments of the invention provide techniques for managing streaming content.

For example, in one embodiment, a method comprises the following steps. One or more operating conditions of a communications network configured to provide at least one content stream to one or more communications devices are monitored. An interstitial transition is selected for insertion into the content stream based on a length of the interstitial transition, in response to the one or more monitored operating conditions of the communications network. The interstitial transition is selected from a plurality of varied-length interstitial transitions.

Further, the method may comprise inserting the selected interstitial transition into the content stream. The one or more operating conditions of the communications network may comprise a jitter condition and/or a bandwidth condition.

Still further, the method may comprise partitioning the content stream into segments. Then, the interstitial selection step may further comprise: (i) selecting, from the plurality of varied-length interstitial transitions, a nominal length interstitial transition for insertion at the end of a segment when a storage condition of a jitter buffer used to store at least part of the content stream is between a lower threshold and an upper threshold; (ii) selecting, from the plurality of varied-length interstitial transitions, a longer-than-nominal length interstitial transition for insertion at the end of the segment when the storage condition of the jitter buffer is below the lower threshold; and (iii) selecting, from the plurality of varied-length interstitial transitions, a shorter-than-nominal length interstitial transition for insertion at the end of the segment when the storage condition of the jitter buffer is above the upper threshold. The segment of the content stream and the selected interstitial transition may be queued for playback.

In another embodiment, the method may comprise adjusting the length of the selected interstitial transition based on the length of a jitter buffer used to store at least part of the content stream.

Advantageously, illustrative embodiments of the invention allow for significantly higher bit rates and increased playback quality for content streams transmitted over a noisy communications network.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a streaming content system, according to one embodiment of the invention.

FIG. 2 illustrates further details of a streaming content system, according to one embodiment of the invention.

FIG. 3 illustrates a streaming content methodology, according to an embodiment of the invention.

FIG. 4 illustrates a processing architecture for communications devices used to implement a streaming content system and methodology, according to an embodiment of the invention.

### DETAILED DESCRIPTION

Embodiments of the invention will be described below in the context of illustrative multimedia streaming applications. However, it is to be understood that embodiments of the invention are not limited to the multimedia applications but are more generally applicable to any content streaming application wherein it is desirable to improve content throughput as well as content playback quality.

As used herein, the term “content” refers to data, information or the like. Thus, for example, a “content stream” is a stream of data that is concurrently received and presented by one or more computing devices to one or more users of the one or more computing devices.

As used herein, the term “multimedia” refers to content that uses a combination of two or more different content forms. The term can be used as a noun (content with multiple content forms) or as an adjective (describing content as having multiple content forms, e.g., multimedia data). The term, multimedia, is used in contrast to media which typically refers to a single content form such as, for example, text-only on a computer display. By way of example only, multimedia can include a combination of text, audio, still images, animation, video, or interactive content forms.

FIG. 1 illustrates a streaming content system, according to one embodiment of the invention. As shown, system 100 illustrates components involved in the delivery of streaming content. Content provider 102 provides one or more content streams to one or more of a plurality of content consumers 104-1 through 104-N via network 106.

It is to be understood that content provider 102 is not necessarily the entity that creates the content to be streamed, but rather may be the entity that receives the content from one or more content originators, creators or sources, and then delivers the content to the content consumers 104. However, content provider 102 could be the source of at least a portion, if not all, of the content to be streamed.

Network 106 may be a communications network, such as a wide area network (WAN), a local area network (LAN), a satellite network, a telephone or cable network, or various portions or combinations of these and other types of networks. Further, network 106 may support wireless connectivity, wired connectivity, or some combination thereof.

Examples of streaming content that can be transmitted by content provider 102 over network 106 to one or more content consumers 104 can include, but are not limited to, Internet television content, live video content, and other multimedia or media content.

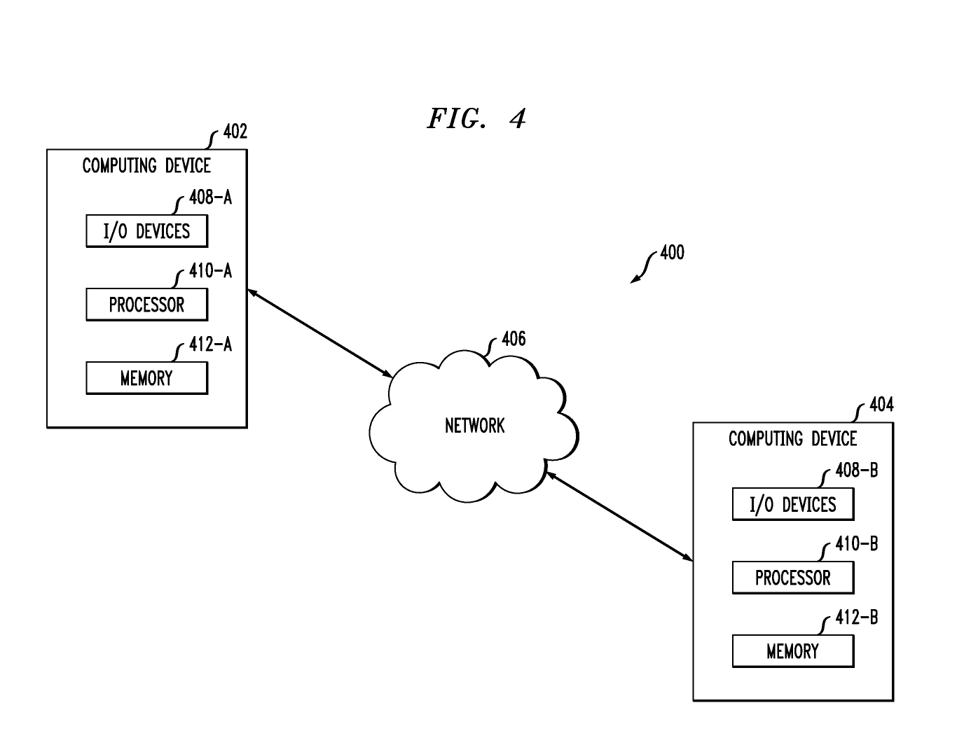

Content provider 102 may be implemented via one or more servers. Content consumers 104-1 through 104-N may each respectively be implemented via a mobile end-user device (e.g., smartphone, tablet, laptop, etc.). However, in some embodiments, one or more end-user devices can act as content providers to other end-user devices or other computing devices. Likewise, one or more of the servers of content provider 102 may act as a content consumer in a given content streaming scenario. Example processing platforms for the servers and end-user devices will be further described below in the context of FIG. 4.

As will be illustrated in further detail below, embodiments of the invention provide techniques for inserting transitions between segments of streaming content at appropriate places in the content stream. Such “interstitial transitions” (or more simply referred to herein as “interstitials”) are one or more transition elements that are inserted between segments of a content stream. Such transition elements may also be inserted at the beginning or end of a content stream. For example, when the content stream is a video stream, such transition elements can be graphics elements. For instance, if the video stream includes a news or sports program, an interstitial transition can include graphics or some graphic effect inserted between events in the news or sports program. By way of further example, the interstitial can be an advertisement (ad) from some advertising sponsor of the news or sports program. In accordance with embodiments of the invention, the time duration of the interstitial is matched to one or more network conditions or desired bandwidth. So if a jitter buffer associated with the streaming video is running low, a relatively long interstitial can be used, whereas if the jitter buffer is running high, a shorter interstitial can be inserted, or even no interstitial at all.

The interstitials can be stored locally, for example, either by pre-loading, saving from previous views, or grabbing marked frames the first time they are streamed. These effects can also be player effects that do not require new video frames such as, but not limited to, freezing a frame, rotating it out of view, and then rotating the next frame of the next clip into view.

Advantageously, in accordance with embodiments of the invention, the length of the interstitial can be chosen to ensure smooth content playback. The type of interstitial chosen (e.g., graphic effect, graphics, ad, etc.) is an entirely different decision, either based upon ad agreements, availability in the end-user device or aesthetic concerns. The length of the interstitial is determined by one or more monitored network conditions. In one or more embodiments, these interstitials can occur relatively frequently, so each adjustment can be relatively small, e.g., on the order of a few video frames. This allows rapid adjustment to fluctuating network conditions.

It is also realized that this type of authoring (i.e., insertion of interstitial transitions into streaming content) can be implemented with the emerging HTML5 standard. In an HTML (HyperText Markup Language) embodiment, real-time (live) authoring in accordance with embodiments of the invention can include differentially rendering the transition element to account for the necessary time. For instance, if a graphic is intended to move from 100 pixels leftward in 10 frames, it can easily be adjusted to moving 100 pixels leftward in 17 or 23 frames.

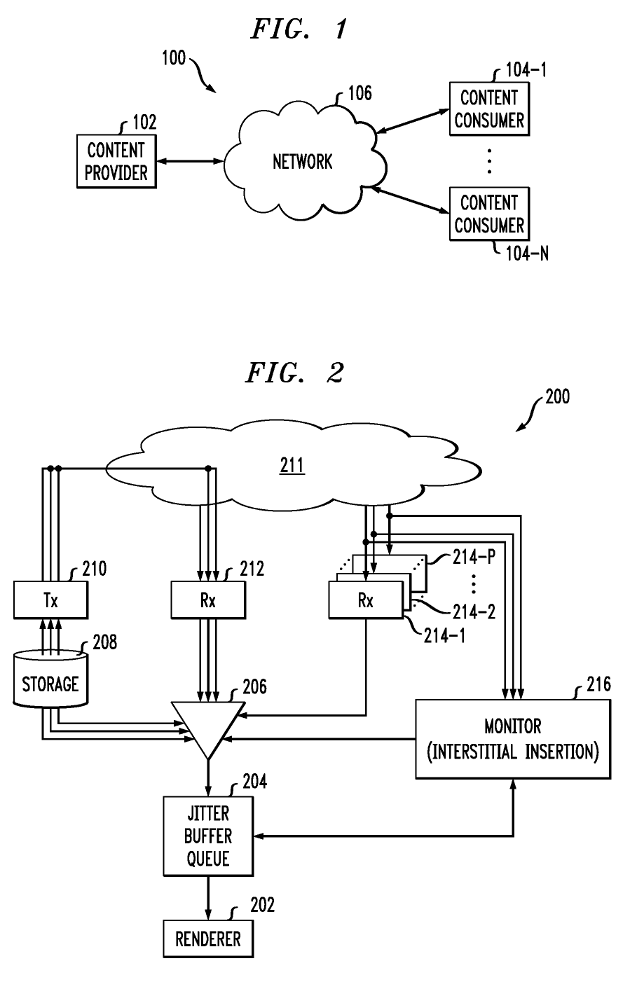

FIG. 2 illustrates further details of a streaming content system with interstitial transition insertion capability, according to one embodiment of the invention. As shown, streaming content system 200 comprises a renderer 202, a jitter buffer queue 204, a selector 206, storage 208, a transmitter 210, a receiver 212, a plurality of receivers 214, and a monitor 216.

It is to be appreciated that, in one or more embodiments, the majority of the components shown in FIG. 2 can be part of a content consumer entity (104 in FIG. 1). However, in other embodiments, certain components can be part of the network (106 in FIG. 1). For example, components 202 and 204 are in the end-user device. Components 206, 208, 216, 212 and 214-1 through 214-P can all be in the end-user device as well, but one or more can alternatively be in the network. Components 210 and 211 are in the network.

The streaming content system 200 operates as follows. Renderer 202 receives content (e.g., video) frames from jitter buffer queue 204. The renderer is the module that renders, in the case of a video stream, the content (i.e., generates visual presentation) for display to a user. Jitter buffer queue 204 receives frames from selector 206, which in turn receives streams from a plurality of sources.

In the embodiment shown, these sources include either: (a) a plurality of streams from local storage (represented as being part of storage 208) of different bit rates; (b) a plurality of streams from a remote storage source (represented as being part of storage 208) transmitted by a transmitter (Tx) 210 over network 211 to a receiver (Rx) 212 and delivered to the selector 206, again of different bit rates; or (c) a plurality of receivers (Rx) 214-1 through 214-P which may or may not be composited into one or more content streams.

Note that storage 208 refers to a storage that can be in the end-user device, or remote from it. If storage 208 is in the end-user device, it feeds into selector 206, and storage 208 and selector 206 are in that same device. If storage 208 is not in the end-user device, then streaming content from storage 208 is transmitted through transmitter 210 over network 211 and received by receiver 212. In that case, receiver 212 and selector 206 would typically be in the end-user device, although they could be in a network component, e.g., a media gateway or network cache. Note also that content provider 102 in FIG. 1 is one example of an entity that provides the content streams received by the plurality of Rx 214-1 through 214-P.

It is assumed that monitor 216 has access to network information on the input of each Rx stream associated with source (c) above, as well as information about the jitter buffer queue state. The monitor determines which streams from either source (a) or source (b) above are selected, i.e., either (a) or (b) is used depending on whether the storage is local or across the network, and within (a) or (b), a particular bit rate stream is selected.

The remote storage content source (received from Rx 212) could represent a cloud deployment (i.e., a distributed virtual infrastructure), where storage is central. As used herein, the term “cloud” refers to a collective computing infrastructure that implements a cloud computing paradigm. For example, as per the National Institute of Standards and Technology (NIST Special Publication No. 800-145), cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. Since this cloud-based storage is highly available and typically nearby to the end-user device, it does not suffer from the network impairments the other Rx streams (received through the plurality of Rx 214-1 through 214-P) suffer from, and can for the monitor's purposes be considered “local.”

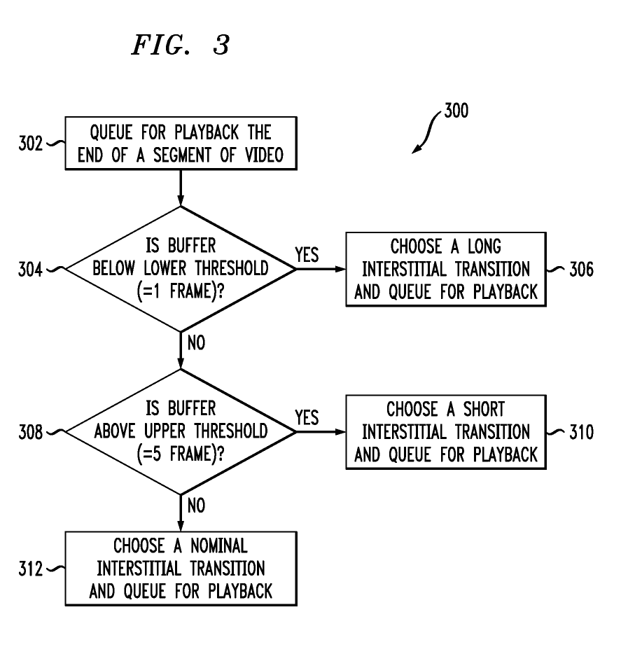

FIG. 3 illustrates a streaming content methodology 300, according to an embodiment of the invention. Methodology 300 can be performed via monitor 216 in FIG. 2 since the monitor is aware of network conditions (e.g., bandwidth limitations) from the received content streams, and is aware of the jitter buffer queue condition (e.g., state). It is to be appreciated that such jitter conditions and network conditions may be considered examples of operating conditions of the communications network. Thus, based on this monitored information, monitor 216 can select and insert interstitial transitions into the content (e.g., via selector 206) in accordance with methodology 300.

It is assumed that a video stream is divided into segments, between which interstitials can be inserted. This segmentation may be manually determined, or automatically determined by any number of existing scene detection algorithms. The segment is indicated directly in the streaming container format, by an index table (such as those used in HTML Adaptive Streaming), or by any other existing technique.

The nominal length of the interstitial transition is also signaled, or implied in the time stamp format. This nominal length is the anticipated time course the video would have played if jitter were not an issue, e.g., the number of frames in a fixed frame per second video. It is also assumed that various types of interstitial transitions are available for selection, although these can be simple frame manipulations not requiring unique video frames (such as, for example, the rotation effect indicated above).

Thus, as shown in FIG. 3, at the time when a segment is queued for playback (step 302) in the player (i.e., end-user device), the decision to insert an interstitial is made. If the jitter buffer queue is within the high and low watermarks (thresholds), a nominal playback rate is chosen (e.g., same number of frames as indicated in the nominal signal). However, as per steps 304 and 306, if the jitter buffer queue is running low (the buffer is below a lower threshold of, for example, 1 frame), a longer interstitial transition is chosen for insertion. Further, as per steps 308 and 310, if the jitter buffer queue is running high (the buffer is above an upper threshold of, for example, 5 frames), a shorter interstitial transition is chosen for insertion. In alternative embodiments, monitor 216 can lengthen or shorten the rendering of the interstitial on-the-fly to match a desired buffer length.

FIG. 4 illustrates a processing architecture 400 for communications devices used to implement a streaming content system and methodology, according to an embodiment of the invention. While FIG. 4 shows detailed subcomponents for only two devices, it is to be understood that other devices in the systems described herein can have the same or similar configurations. Thus, in terms of the streaming content and interstitial insertion methodologies described herein, the two devices shown in detail may be a content provider 102 and a content consumer 104 shown in FIG. 1. However, other components in FIGS. 1-3 may be implemented with the same or similar architecture as shown in a computing device of FIG. 4. For the sake of simplicity, all the computing devices that may participate in the methodologies of the invention are not shown in FIG. 4.

As shown, computing device 402 (e.g., content provider 102) and computing device 404 (e.g., content consumer 104) are coupled via a network 406. The network may be any network across which the devices are able to communicate, for example, as in the embodiments described above, the network 506 could include a publicly-accessible wide area communication network such as a cellular communication network and/or the Internet and/or a private intranet. However, embodiments of the invention are not limited to any particular type of network. Note that when the computing device is a content provider, it could be considered a server, and when the computing device is a content consumer, it could be considered a client. Nonetheless, the methodologies of the present invention are not limited to cases where the devices are clients and/or servers, but instead are applicable to any computing (processing) devices.

As would be readily apparent to one of ordinary skill in the art, the computing devices may be implemented as programmed computers operating under control of computer program code. The computer program code would be stored in a computer readable storage medium (e.g., a memory) and the code would be executed by a processor of the computer. Given this disclosure of the invention, one skilled in the art could readily produce appropriate computer program code in order to implement the methodologies described herein.

As shown, device 402 comprises I/O devices 408-A, processor 410-A, and memory 412-A. Device 404 comprises I/O devices 408-B, processor 410-B, and memory 412-B.

It should be understood that the term “processor” as used herein is intended to include one or more processing devices, including a central processing unit (CPU) or other processing circuitry, including but not limited to one or more video signal processors, one or more integrated circuits, and the like.

Also, the term “memory” as used herein is intended to include memory associated with a video signal processor or CPU, such as RAM, ROM, a fixed memory device (e.g., hard drive), or a removable memory device (e.g., diskette or CDROM). Also, memory is one example of a computer readable storage medium.

In addition, the term “I/O devices” as used herein is intended to include one or more input devices (e.g., keyboard, mouse) for inputting data to the processing unit, as well as one or more output devices (e.g., CRT display) for providing results associated with the processing unit. Further, an input device can be a content stream receiver (Rx), while an output device can be a content stream transmitter (Tx).

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU.

Advantageously, embodiments of the invention as illustratively described herein allow a significantly higher bit rate associated with streaming content. Transition effects are used when a video encoder needs to dedicate a large number of bits to a frame. Embodiments of the invention naturally allow that frame to trickle in, increasing the quality of playback, reducing the bit rate, and ensuring smooth playback over a noisy network. By way of example only, there are immediate savings if only about 50-55 seconds of video are transmitted about every 60 seconds. Specially authored events (common for mobile video) can decrease live content to maybe 40 seconds or so, allowing greater savings.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
monitoring one or more operating conditions of a communications network configured to provide at least one content stream to one or more communications devices; and
selecting an interstitial transition for insertion into the content stream based on a length of the interstitial transition, in response to the one or more monitored operating conditions of the communications network, wherein the interstitial transition is selected from a plurality of varied-length interstitial transitions.

2. The method of claim 1, further comprising inserting the selected interstitial transition into the content stream.

3. The method of claim 1, wherein the one or more operating conditions of the communications network comprise a jitter condition.

4. The method of claim 1, wherein the one or more operating conditions of the communications network comprise a bandwidth condition.

5. The method of claim 1, further comprising partitioning the content stream into segments.

6. The method of claim 5, wherein the interstitial selection step further comprises selecting, from the plurality of varied-length interstitial transitions, a nominal length interstitial transition for insertion at the end of a segment when a storage condition of a jitter buffer used to store at least part of the content stream is between a lower threshold and an upper threshold.

7. The method of claim 6, wherein the interstitial selection step further comprises selecting, from the plurality of varied-length interstitial transitions, a longer-than-nominal length interstitial transition for insertion at the end of the segment when the storage condition of the jitter buffer is below the lower threshold.

8. The method of claim 6, wherein the interstitial selection step further comprises selecting, from the plurality of varied-length interstitial transitions, a shorter-than-nominal length interstitial transition for insertion at the end of the segment when the storage condition of the jitter buffer is above the upper threshold.

9. The method of claim 5, further comprising queuing a segment of the content stream and the selected interstitial transition for playback.

10. The method of claim 1, further comprising adjusting the length of the selected interstitial transition based on the length of a jitter buffer used to store at least part of the content stream.

11. An apparatus, comprising:
a memory; and
a processor device coupled to the memory and configured to:
monitor one or more operating conditions of a communications network configured to provide at least one content stream to one or more communications devices; and
select an interstitial transition for insertion into the content stream based on a length of the interstitial transition, in response to the one or more monitored operating conditions of the communications network, wherein the interstitial transition is selected from a plurality of varied-length interstitial transitions.

12. The apparatus of claim 11, wherein the processor device is further configured to insert the selected interstitial transition into the content stream.

13. The apparatus of claim 11, wherein the one or more operating conditions of the communications network comprise at least one of a jitter condition and a bandwidth condition.

14. The apparatus of claim 11, wherein the interstitial selection step further comprises selecting, from the plurality of varied-length interstitial transitions, a nominal length interstitial transition for insertion at the end of a segment of the content stream when a storage condition of a jitter buffer used to store at least part of the content stream is between a lower threshold and an upper threshold.

15. The apparatus of claim 14, wherein the interstitial selection step further comprises selecting, from the plurality of varied-length interstitial transitions, a longer-than-nominal length interstitial transition for insertion at the end of the segment when the storage condition of the jitter buffer is below the lower threshold.

16. The apparatus of claim 14, wherein the interstitial selection step further comprises selecting, from the plurality of varied-length interstitial transitions, a shorter-than-nominal length interstitial transition for insertion at the end of the segment when the storage condition of the jitter buffer is above the upper threshold.

17. The apparatus of claim 11, wherein the processor device is further configured to queue a segment of the content stream and the selected interstitial transition for playback.

18. The apparatus of claim 11, wherein the processor device is further configured to adjust the length of the selected interstitial transition based on the length of a jitter buffer used to store at least part of the content stream.

19. The apparatus of claim 11, wherein the memory and processor device are part of one of the one or more communications devices.

20. An article of manufacture, comprising:
a computer readable storage medium; and
one or more computer executable instructions stored on the computer readable storage medium that, when executed by a processing device, perform steps of:
monitoring one or more operating conditions of a communications network configured to provide at least one content stream to one or more communications devices; and
selecting an interstitial transition for insertion into the content stream based on a length of the interstitial transition, in response to the one or more monitored operating conditions of the communications network, wherein the interstitial transition is selected from a plurality of varied-length interstitial transitions.
